(19) United States
(12) Patent Application Publication
(10) Pub. No.: US 2025/0150266 A1
(43) Pub. Date: May 8, 2025

(54) SENSORY COMMUNICATION SYSTEM, SENSORY COMMUNICATION METHOD, AND STORAGE MEDIUM

(71) Applicant: JVCKENWOOD Corporation, Yokohama-shi (JP)

(72) Inventor: Takayuki Sugahara, Yokohama-shi (JP)

(21) Appl. No.: 19/017,863

(22) Filed: Jan. 13, 2025

Related U.S. Application Data
(63) Continuation of application No. PCT/JP2023/033148, filed on Sep. 12, 2023.

(30) Foreign Application Priority Data
Sep. 22, 2022 (JP) 2022-150835

(51) Int. Cl. H04L 9/08; H04L 9/40

(52) U.S. Cl. CPC H04L 9/0852; H04L 63/0428

(57) ABSTRACT

A sensory transmission system includes a sending device that encrypts brain activity information, which is based on the brain activity of a test subject, using key information, and sends the brain activity information in the encrypted form; a receiving device that receives the brain activity information sent from the sending device, and decrypts the received brain activity information using the key information; and a delivery device that delivers the key information to the sending device and the receiving device using quantum entanglement.

### CROSS-REFERENCE TO RELATED APPLICATIONS

This application is a Continuation of PCT International Application No. PCT/JP2023/033148 filed on Sep. 12, 2023 which claims the benefit of priority from Japanese Patent Application No. 2022-150835 filed on Sep. 22, 2022, the entire contents of both of which are incorporated herein by reference.

### BACKGROUND OF THE INVENTION

### 1. Field of the Invention

The application concerned relates to a sensory communication system, a sensory communication method, and a computer program product.

### 2. Description of the Related Art

In recent years, there are advances in the technology such as functional magnetic resonance imaging or near-infrared spectroscopy that is measures the brain activation information in a non-invasive manner, and the technology of a brain-machine interface representing an interface between the brain and the outside world is becoming more and more realistic. As an example in which such a technology is implemented, a technology has been disclosed in which the brain activation information is detected in a case where the test subject perceives something and, based on the detected brain activation information, recall sensory information that is recalled against the perception of the test subject is set as a message (for example, refer to Japanese Patent Application Laid-open No. 2014-115913).

In the technology disclosed in Japanese Patent Application Laid-open No. 2014-115913, the recall sensory information of the test subject represents, what is called, personal information. From the perspective of protecting the personal information, it requires appropriate handling of the recall sensory information of the test subject.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A sensory transmission system apparatus according to the present disclosure comprising:
a sending device that encrypts brain activity information, which is based on brain activity of a test subject, using key information, and sends the brain activity information in encrypted form;
a receiving device that receives the brain activity information sent from the sending device, and decrypts the received brain activity information using the key information; and
a delivery device that delivers the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.

A sensory communication method apparatus according to the present disclosure comprising:
encrypting, in a sending device, that includes encrypting brain activity information, which is based on brain activity of a test subject, using key information, and sending the brain activity information in encrypted form;
decrypting, in a receiving device, that includes receiving the brain activity information sent from the sending device, and decrypting the received brain activity information using the key information; and
delivering, in a delivery device, that includes delivering the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.

A non-transitory computer-readable storage medium storing a program causing a computer apparatus according to the present disclosure to execute,
by a sending device, causes the sending device to perform encrypting brain activity information, which is based on brain activity of a test subject, using key information, and sending the brain activity information in encrypted form;
by a receiving device, causes the receiving device to perform receiving the brain activity information sent from the sending device, and decrypting the received brain activity information using the key information; and
by a delivery device, causes the delivery device to perform delivering the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.

### BRIEF DESCRIPTION OF THE DRAWINGS

FIG. 1 is a schematic diagram illustrating an example of a sensory communication system according to a first embodiment;

FIG. 2 is a functional block diagram illustrating an example of the sensory communication system according to the first embodiment;

FIG. 3 is a diagram illustrating an example of a neural network;

FIGS. 4 and 5 are diagrams that schematically illustrate an example of the operations performed in the sensory communication system according to the first embodiment;

FIG. 6 is a flowchart for explaining an example of the operations performed in the sensory communication system according to the first embodiment;

FIG. 7 is a diagram that schematically illustrates another example of the operations performed in the sensory communication system according to a second embodiment; and

FIG. 8 is a diagram that schematically illustrates another example of the operations performed in the sensory communication system according to a third embodiment.

### DETAILED DESCRIPTION OF THE PREFERRED EMBODIMENTS

Exemplary embodiments of the application concerned are described below with reference to the accompanying drawings. However, the present invention is not limited by the embodiments described below. Moreover, the constituent elements according to the embodiments described below include constituent elements that are simple and that can be replaced with other constituent elements by a person skilled in the art, or include practically identical constituent elements.

### First Embodiment

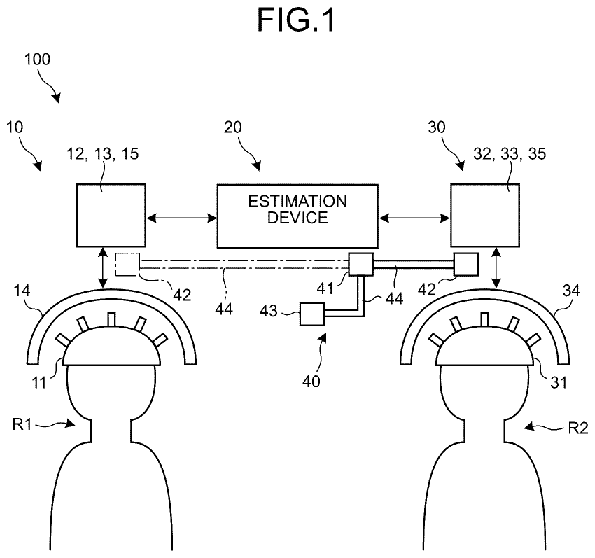

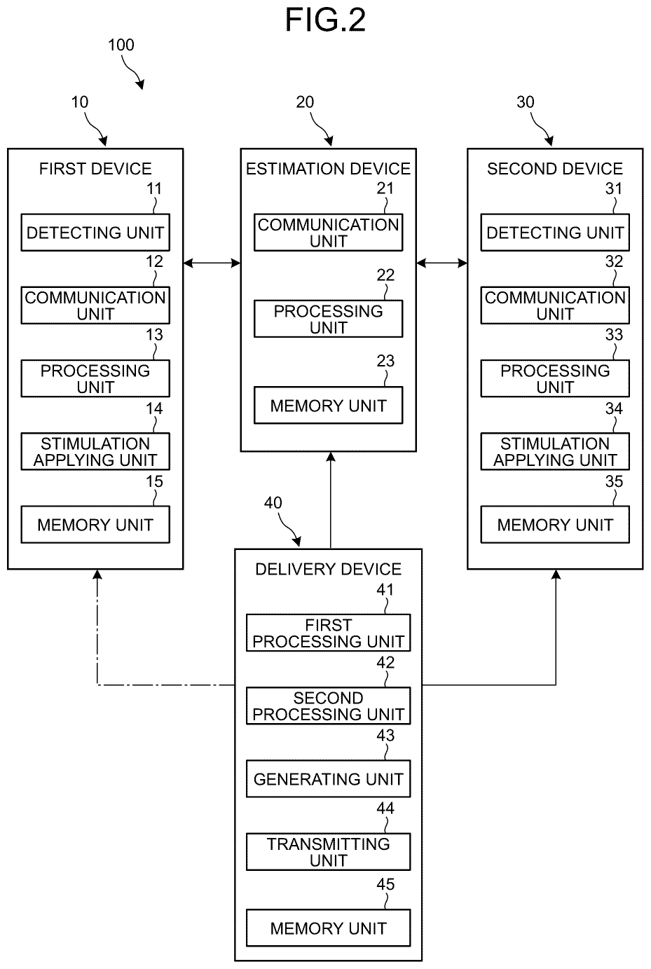

FIG. 1 is a schematic diagram illustrating an example of a sensory communication system 100 according to a first embodiment. FIG. 2 is a functional block diagram illustrating an example of the sensory communication system 100. As illustrated in FIGS. 1 and 2, the sensory communication system 100 includes a first device 10, an estimation device (a sending device) 20, a second device (a receiving device) 30, and a delivery device 40.

The first device 10 detects brain activation information of a first test subject R1 in a case where the first test subject R1 perceives something. In the first embodiment, the brain activation information represents the information that is based on the brain activity of the first test subject R1. The first device 10 includes a detecting unit 11, a communication unit 12, a processing unit 13, a stimulation applying unit 14, and a memory unit 15.

The detecting unit 11 detects the brain activation information. Examples of the brain activation information include the oxyhemoglobin concentration, the deoxyhemoglobin concentration, and the total hemoglobin concentration in the cerebral blood flow of the test subject. As the detecting unit 11, for example, it is possible to use a measurement device that performs measurement based on the principle of functional magnetic resonance imaging (fMRI) or functional near-infrared spectroscopy (fNIRS); or a measurement device in which an invasive-type electrode is used; or a measurement device having micromachines placed inside the blood vessels of the brain and performs measurement using the micromachines. However, the detecting unit 11 is not limited to the devices mentioned above, and some other device can also be used. For example, when the brain of the first test subject R1 is compartmentalized using a three-dimensional matrix made of voxels having the size equal to or smaller than few millimeters, the brain activation information can be represented as the degree of activity on a voxel-by-voxel basis.

The communication unit 12 is an interface for performing wired communication or wireless communication. The communication unit 12 sends the brain activation information, which is detected by the detecting unit 11, to the estimation device 20. The communication unit 12 includes an interface for performing communication with external devices using, what is called, a wireless LAN according to the IEEE 802.11. The communication unit 12 can perform communication with external devices under the control of a processing unit 22. Herein, the communication method is not limited to a wireless LAN, and it is alternatively possible to implement some other wireless communication method such as infrared communication, Bluetooth (registered trademark) communication, or a wireless USB. Still alternatively, it is possible to use a wireless connection such as a USB cable, HDMI (registered trademark), IEEE 1394, or Ethernet.

Regarding the processing unit 13, the stimulation applying unit 14, and the memory unit 15; the explanation is given later. The processing unit 13 includes a processing device such as a central processing unit (CPU), and includes a memory device such as a random access memory (RAM) or a read only memory (ROM). Meanwhile, in the first embodiment, the processing unit 13, the stimulation applying unit 14, and the memory unit 15 need not be included in the configuration.

The estimation device 20 includes a communication unit 21, a processing unit 22, and a memory unit 23. The communication unit 21 is an interface for performing wired communication or wireless communication. For example, the communication unit 21 receives the brain activation information that is sent from the first device 10. Moreover, for example, the communication unit 21 sends, to the second device 30, associated sensory information (explained later) that is estimated by the processing unit 22. The communication unit 21 can have an identical configuration to the communication unit 12 explained earlier.

The processing unit 22 includes a processing device such as a CPU, and includes a memory device such as a RAM or a ROM. The processing unit 22 performs various operations including an estimation operation (explained later).

The memory unit 23 is used to store a variety of information. For example, the memory unit 23 includes a storage such as a hard disk drive or a solid state drive. Alternatively, as the memory unit 23, it is also possible to use an external memory medium such as a removable disk. The memory unit 23 is used to store a computer program that causes the estimation device 20 to perform an operation in which the brain activity information, which is based on the brain activity of the test subject, is encrypted using key information, and the brain activity information in the encrypted form is sent.

Based on the detected brain activation information of the first test subject R1, the processing unit 22 estimates the recall sensory information (reference sensory information) about the sensation recalled by the first test subject R1 against some perception. In the first embodiment, the recall sensory information represents the information estimated based on the brain activity of the first test subject R1. Thus, the recall sensory information represents the brain activity information based on the brain activity occurring in the first test subject R1. The recall sensory information either can represent the information related to at least one of, what are called, the five senses, namely, the sense of vision, the sense of hearing, the sensor of touch, the sense of taste, and the sense of smell; or can represent the sense of balance; or can represent some other somatic sense other than the senses mentioned above. More particularly, when the recall sensory information represents the information related to the sense of vision, the recall sensory information indicates the image data perceived by the first test subject R1. However, that is not the only possible case. Thus, instead of indicating the actual image data, the recall sensory information can indicate the image data sampled from the actual image data, or can indicate the image data obtained by filtering the actual image. Moreover, when the recall sensory information represents the information related to the sense of vision, the recall sensory information can indicate the information related to the light entering the eyes of the first test subject R1. In that case, for example, the information related to the light can be obtained using a contact lens that is equipped with an optical sensor. Alternatively, the information related to the light can be obtained with the aid of an artificial retina. More particularly, it is possible to use the information related to the light of the CCD sensor that is installed in an artificial retina. When the recall sensory information represents the information related to the sense of hearing, it serves the purpose if the recall sensory information is audio signal data perceived by the first test subject R1. When the recall sensory information represents the information related to the sense of taste, it serves the purpose if the recall sensory information is data indicating the index of a plurality of chemical substances that reproduces the sense of taste perceived by the first test subject R1. When the recall sensory information represents the information related to the sense of touch, it serves the purpose if the recall sensory information is data that, when the total body surface of the first test subject R1 is expanded in a plane, indicates what extent of stimulation occurred in which portion of the expansion plan. Meanwhile, the types of the recall sensory information explained above are only exemplary, and the recall sensory information is not limited to those types. Regarding the first test subject R1, an experiment can be performed in advance, and recalling what type of recall sensory information results in what type of brain activation information can be obtained as the correspondence relationship. For example, the brain activation information detected from the first test subject R1 and the recall sensory information corresponding to the brain activation information can be associated as a single learning dataset, and a first learning model can be generated by performing machine learning of that learning dataset. The first learning model can be stored in, for example, the memory unit 23.

Moreover, based on the estimated reference sensory information, the processing unit 22 estimates the associated sensory information that represents the recall sensory information corresponding to the reference sensory information regarding a second test subject R2 who is different than the first test subject R1. Herein, a specific example of the associated sensory information can be equivalent to the specific example of the recall sensory information. The second test subject R2 represents the test subject to whom the sensation of the first test subject R1 is communicated. The reference sensory information and the association sensory information can be associated to each other by performing an experiment in advance. For example, the recall sensory information corresponding between the first test subject R1 and the second test subject R2 can be treated as a single learning dataset, and a second learning model can be generated by performing machine learning of that learning dataset. The second learning model can be stored in, for example, the memory unit 23. The associated sensory information is estimated based on the recall sensory information of the first test subject R1. Thus, in the first embodiment, the recall sensory information represents the brain activity information based on the brain activity of the first test subject R1.

Furthermore, the processing unit 22 encrypts the associated sensory information that has been estimated. The processing unit 22 extracts key information based on the quantum state of the quanta delivered from the delivery device 40 (explained later), and encrypts the associated sensory information according to the extracted key information. Then, the processing unit 22 causes the communication unit 21 to send the associated sensory information in the encrypted form. Thus, in the first embodiment, the estimation device 20 represents a sending device that encrypts the recall sensory information, which represents the brain activity information, using the key information; and then sends the encrypted information.

The second device 30 applies a stimulation to the second test subject R2 in such a way that the associated sensory information, which has been estimated, gets recalled. The second device 30 includes a detecting unit 31, a communication unit 32, a processing unit 33, a stimulation applying unit 34, and a memory unit 35.

Regarding the detecting unit 31, the explanation is given later. As the detecting unit 31, for example, it is possible to use a measurement device that performs measurement based on the principle of functional magnetic resonance imaging (fMRI) or functional near-infrared spectroscopy (fNIRS); or a measurement device in which an invasive-type electrode is used; or a measurement device having micromachines placed inside the blood vessels of the brain and performs measurement using the micromachines. Meanwhile, in the first embodiment, the detecting unit 31 need not be included in the configuration.

The communication unit 12 is an interface for performing wired communication or wireless communication. The communication unit 32 receives the associated sensory information that is sent from the estimation device 20. Moreover, the communication unit 32 sends the brain activation information, which is detected by the detecting unit 31, to the estimation device 20. The communication unit 32 can have an identical configuration to the communication unit 12 explained earlier.

The processing unit 33 decrypts the associated sensory information that is received by the communication unit 32. The processing unit 33 includes a processing device such as a CPU, and includes a memory device such as a RAM or a ROM. The processing unit 33 decrypts the associated sensory information using the key information delivered from the delivery device (explained later). In the first embodiment, the second device 30 is a receiving device that receives the recall sensory information representing the brain activity information, and decrypts the recall sensory information using the key information. Moreover, based on the associated sensory information in the decrypted form and based on a third learning model (explained later), the processing unit 33 can calculate stimulation image information corresponding to the associated sensory information that is received.

The third learning model is a learning model in which the stimulation image information (explained later) with respect to the second test subject R2 and the associated sensory information, which represents the recall sensory information that is recalled by the second test subject R2 when electromagnetic waves are bombarded based on the stimulation image information, is associated to each other as a single learning dataset, and the learning dataset is subjected to machine learning. The third learning model can be stored in, for example, the memory unit 35 of the second device 30.

The stimulation applying unit 34 bombards electromagnetic wave signals onto the target region in the brain of the second test subject R2 and activates the target region so as to stimulate the second test subject R2. In this case, the brain of the second test subject R2 is compartmentalized using, for example, a three-dimensional matrix made of voxels having the size equal to or smaller than few millimeters, and electromagnetic waves are bombarded on a voxel-by-voxel basis. The stimulation applying unit 34 can bombard electromagnetic waves based on the stimulation image information indicating the intensity of the electromagnetic waves to be bombarded and indicating the voxels in the three-dimensional matrix onto which the electromagnetic waves are to be bombarded. The voxels in the three-dimensional matrix of the stimulation image information and the voxels in the three-dimensional matrix of the brain activation information can have mutually corresponding dimensions and positions. Regarding the information about what intensity of electromagnetic waves when bombarded onto which pixels in the brain of the second test subject R2 leads to the recall of what type of recall sensory information, the correspondence relationship can be obtained by performing an experiment in advance.

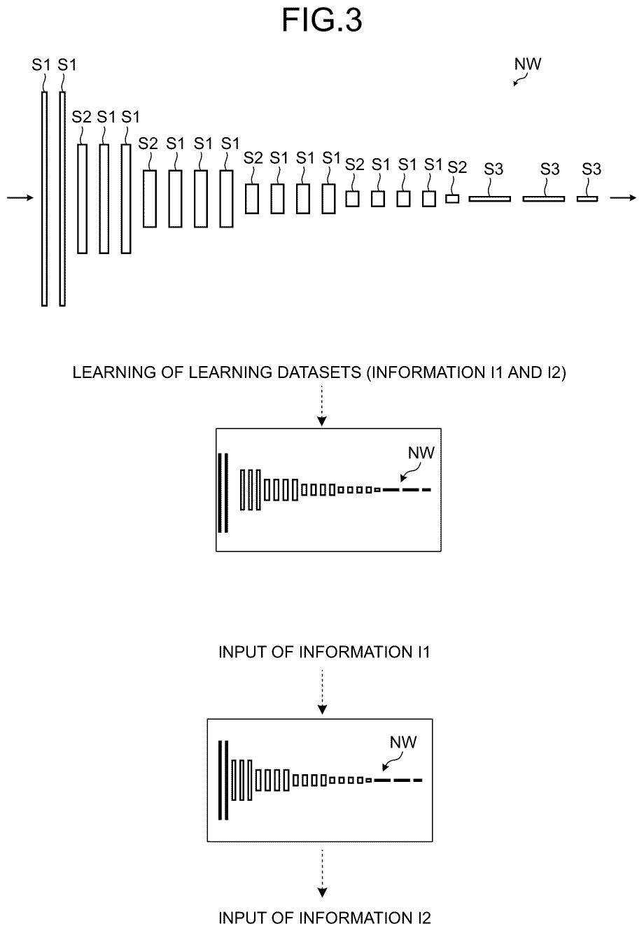

The first learning model, the second learning model, and the third learning model can be generated using, for example, a neural network (a convolutional neural network) represented by VGG16. FIG. 3 is a diagram illustrating an example of a neural network. As illustrated in the upper part of FIG. 3, a neural network NW includes 13 convolution layers S1, five pooling layers S2, and three fully-connected layers S3. In the neural network, the input information is processed in the convolution layers S1 and in the pooling layers S2 in that order; the processing results are connected in the fully-connected layers S2; and the connection result is output.

At the time of generating the first learning model, the second learning model, and the third learning model; as illustrated in the middle part of FIG. 3, learning datasets including information (I1, I2) corresponding to the learning models are input to the neural network NW, and the correlation among the learning datasets is learnt according to machine learning such as deep learning. Thus, the neural network NW is optimized by means of learning, and learning models are generated. For example, the learning is performed in such a way that, when one set of information from among the information constituting the learning datasets is input, the problem of obtaining that set of information is solved.

At the time of making an inference using the first learning model, the second learning model, and the third learning model; as illustrated in the lower part of FIG. 3, the information I1 from among the information constituting the learning datasets is input to the network NW. Then, based on the result of learning about the correlation among the information constituting the learning data, the other information I2 corresponding to the input information I1 is output from the first learning model, the second learning model, and the third learning model. Meanwhile, in the first embodiment, although the explanation is given about generating learning models using a convolutional neural network represented by VGG16, the neural network is not limited to that example, and learning models can be generated using other types of neural networks too.

The memory unit 35 is used to store a variety of information. For example, the memory unit 35 includes a storage such as a hard disk drive or a solid state drive. Alternatively, as the memory unit 35, it is also possible to use an external memory medium such as a removable disk. The memory unit 35 is used to store a computer program that causes the second device 30 to receive the brain activity information sent from the estimation device 20 and to decrypt the received brain activity information using key information.

The delivery device 40 delivers the key information, which is to be used in the decryption performed in the estimation device 20 and the decryption performed in the second device 30, to the estimation device 20 and the second device 30 using quantum entanglement. The delivery device 40 delivers the key information to the estimation device 20 and the second device 30 before the encryption of the associated sensory information is carried out in the estimation device 20.

Given below is the explanation of the principle of delivering the key information using quantum entanglement. For example, with respect to a pair of quanta (quantum bits) having level|0> and level|1> as the base, the level|0> is excited to a level|e> and, with respect to the quantum bit returning from the level|e> to the level|0>, the level|0> is substituted with the level|1>; and it is ensured that the state of the complex system cannot be expressed as the product of the quantum states of the individual partial systems constituting the complex system. Meanwhile, “|X>| represents the base vector. Herein, of the pair of quanta, the quantum state of the first quantum is observed, and the quantum state of the second quantum is determined.

Regarding the quantum bits (a first quantum and a second quantum) that are in the relationship of quantum entanglement, the state of overlapping base states is represented by |00>, |01>, |10>, |11>. As the bell state, the base vector becomes as follows:

$$\vert Φ + 〉 = 1 / √ 2 ( \vert 00 〉 + \vert 11 〉 ) \\ \vert Φ - 〉 = 1 / √ 2 ( \vert 00 〉 - \vert 11 〉 ) \\ \vert Ψ + 〉 = 1 / √ 2 ( \vert 01 〉 + \vert 10 〉 ) \\ \vert Ψ - 〉 = 1 / √ 2 ( \vert 01 〉 - \vert 11 〉 )$$

In this state, of the quantum bits, if the quantum state of one quantum is varied, it is observed that the quantum state of the other quantum also gets affected. Meanwhile, as such quanta, it is possible to use, for example, photons or electrons. In the case of photons, the direction of polarization represents the quantum state. In the case of electrons, the direction of spin represents the quantum state.

For example, a different third quantum assigned with the key information to be encrypted (for example, information about “0” or “1”) is interfaced with respect to the first quantum. Due to the consequence of the quantum mechanics, the third quantum and the first quantum are observed to be interfacing and, in exchange for obtaining the observation value, the original information is lost. Herein, based on the obtained observation value, the quantum state of the first quantum becomes clear. As a result, the quantum state gets finalized also for the second quantum that is in the relationship of quantum entanglement with the first quantum.

In light of the explanation given above, for example, the first quantum is delivered to the estimation device 20, the second quantum is delivered to the second device 30, the observation of the first quantum is performed in the estimation device 20, and the observation result obtained regarding the first quantum is communicated to the second quantum. Then, in the second device 30, based on the observation value that is communicated, the quantum state of the second quantum is determined; and, by observing the quantum state of the second quantum, it becomes possible to obtain the quantum state of the third quantum, that is, to obtain the key information.

The delivery device 40 includes a first processing unit 41, a second processing unit 42, a generating unit 43, a transmitting unit 44, and a memory unit 45. The first processing unit 41 is disposed corresponding to the estimation device 20. The second processing unit 42 is disposed corresponding to the second device 30. The first processing unit 41 as well as the third processing unit 42 includes a processing device such as a CPU, and includes a memory device such as a RAM or a ROM. Regarding the first processing unit 41 and the second processing unit 42, the explanation is given later.

The generating unit 43 generates a pair of quanta having the relationship of quantum entanglement. The generating unit 43 can generate a pair of quanta using, for example, some of the atoms present inside the brain of the first test subject. In that case, for example, the generating unit 43 can generate quanta by applying energy to the elementary particles, such as the elementary particles present inside the brain of the first test subject and the elementary particles present inside a brain-invasive device that is directly interfaced inside the brain of the first test subject. Meanwhile, the generating unit 43 can be configured in such a way that at least some part thereof can be disposed inside the brain or inside the body of the first test subject.

As the energy to be applied to the elementary particles inside the brain of the test subject, for example, it is possible to use the energy present inside and outside the body of the test subject. In the case of using the energy present outside the body of the test subject, for example, in the non-radiative region, it is possible to implement the electromagnetic induction method or the magnetic resonance method; and, in the radiative region, it is possible to implement the microwave method. Alternatively, it is possible to use gamma photons of the electromagnetic waves coming from a controlled radiation source that induces vacuum collapse. In the case of using the energy present inside the body of the test subject, for example, the brain can be equipped with the function of generating a bioelectric current (brain waves or a muscle current) of the nerve cells (protein) by means of the biofeedback technique, and the energy can be obtained.

Examples of generating photons include: generating photons by parametric resonance using a compact semiconductor that generates pulsed laser; generating protons by resonance hyper-parametric scattering; and generating photons by polarization using photonic crystals (an independent vector quantity). Alternatively, for example, it is also possible to use the electrons present in the biological atoms inside the brain or to use the photons generated from the electron orbit when the energy level is varied.

Regarding the quantum entanglement, it serves the purpose as long as the quantum entanglement can be presented by means of, for example, wavelength, polarization, beam cross-section, time, physical vector quantity, or spin. Alternatively, the quantum entanglement can be represented by the physical quantity of a multidimensional space by taking into account the dimension of a degenerate field that is equal to or greater than the three-dimensional space and time.

In the case of using photons as the quanta, for example, the generating unit 43 can cause the generated photons to fall on a nonlinear optical system such as parametric down-conversion and generate a pair of quanta having the relationship of quantum entanglement.

In the case of searching for a pair of quanta having the relationship of quantum entanglement, the search can be performed using, for example, quantum tomography. In that case, a density matrix is obtained that is equivalent to the quantum state density distribution of a quantum-mechanical physical system in an unknown condition; front-end checking of high accuracy is performed; and, regarding the elementary particles inside the brain in the current environment in which the brain is placed, it is evaluated in advance about whether or not the positions and the physical quantity of the elementary particles indicate a probabilistically high degree of entanglement. If the degree of entanglement is high, those elementary particles can be adapted as a pair of quanta. Moreover, if the redundancy is enhanced by performing the evaluation in a repeated manner, due to the statistical multiplexing effect, it becomes possible to enhance the angle for searching for the pair of quanta having the highest degree of entanglement. Herein, depending on the evaluation result, the redundancy (the repeat count) can be increased or reduced.

When the estimation device 20 estimates the recall sensory information having predetermined content, the generating unit 43 can generate photons and bombard onto the nonlinear optical system. Examples of the predetermined content include the content indicating that the first test subject R1 recalls “to encrypt and send”. When the recall sensory information estimated in the estimation device 20 contains the content indicating that the first test subject R1 recalls “to encrypt and send”; before sending the recall sensory information to the second device 30, the estimation device 20 notifies the delivery device 40 about the fact that the recall sensory information contains the predetermined content. In that case, in the delivery device 40, based on the notification, the generating unit 43 can generate photons and bombard them onto the nonlinear optical system so as to generate a pair of quanta having the relationship of quantum entanglement. Meanwhile, the predetermined content can be different from the content indicating recalling of “to encrypt and send”, and can be a predetermined mark.

Given below is the more specific explanation of the configuration in which, when the recall sensory information having predetermined content is estimated by the estimation device 20, the generating unit 43 generates photons and bombards them onto the nonlinear optical system. In the estimation device 20, the memory unit 23 is used to store the predetermined content in advance. The communication unit 21 receives brain activation information 52 that is sent from the first device 10. The processing unit 22 obtains the predetermined content from the memory unit 23. Then, the processing unit 22 determines whether or not the predetermined content is included in recall sensory information 51 that is estimated from the brain activation information 52. If the processing unit 22 determines that the predetermined content is included, the communication unit 21 notifies the transmitting unit 44 of the delivery device 40 about the fact that the recall sensory information contains the predetermined content. Upon receiving the notification indicating that the predetermined content is included, the generating unit 43 generates photons based on the notification. When the generated photons are bombarded onto a nonlinear optical system, it becomes possible to generate a pair of quanta having the relationship of quantum entanglement. Meanwhile, if it is not determined that the predetermined content is included, the processing unit 22 can encrypt an associated sensory information 54 and generate the key information. Then, without using quantum entanglement, the processing unit 22 sends the key information to the second device 30 (or to the first device 10 or to the delivery device 40) via the communication unit 21 by performing wired communication or wireless communication.

From among the generated quantum bits, the transmitting unit 44 transmits the first quantum to the first processing unit 41 and transmits the other second quantum to the second processing unit. As the transmitting unit 44, it is possible to use a transmission path capable of transmitting quanta. When photons are used as the quanta (the first quantum and the second quantum), for example, an optical fiber can be used as the transmitting unit 44.

In the delivery device 40, the first processing unit 41 observes the quantum state of the transmitted first quantum. Then, the first processing unit 41 sends, to the second processing unit 42, a first observation result obtained as a result of performing observation.

The second processing unit 42 observes the quantum state of the transmitted second quantum. Moreover, the second processing unit 42 determines the quantum state of the second quantum based on the observation result sent from the first processing unit 41. Then, the second processing unit 42 sends, to the first processing unit 41, a second observation result obtained as a result of performing observation and a determination result obtained as a result of performing determination.

The first processing unit 41 as well as the second processing unit 42 generates key information based on the first observation result, the second observation result, and the determination result. For example, if the second observation result corresponding to the first observation result is not obtained or if the second observation result and the determination result are different, the first processing unit 41 and the second processing unit 42 can generate key information by excluding the information assigned to the concerned quanta. The first processing unit 41 delivers the generated key information to the estimation device 20. The second processing unit 42 delivers the generated key information to the second device 30.

The memory unit 45 is used to store a variety of information. The memory unit 45 includes a storage such as a hard disk drive or a solid state drive. Alternatively, as the memory unit 45, it is also possible to use an external memory medium such as a removable disk. The memory unit 45 is used to store a computer program that causes the delivery device 40 to perform the operation of delivering the key information to the estimation device 20 and the second device 30 using quantum entanglement.

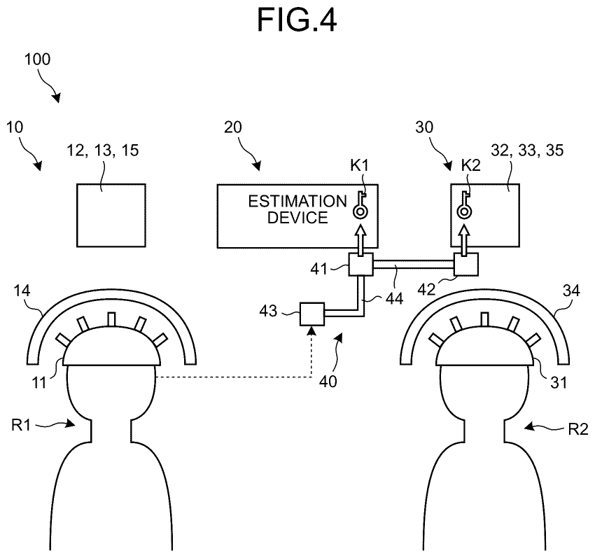

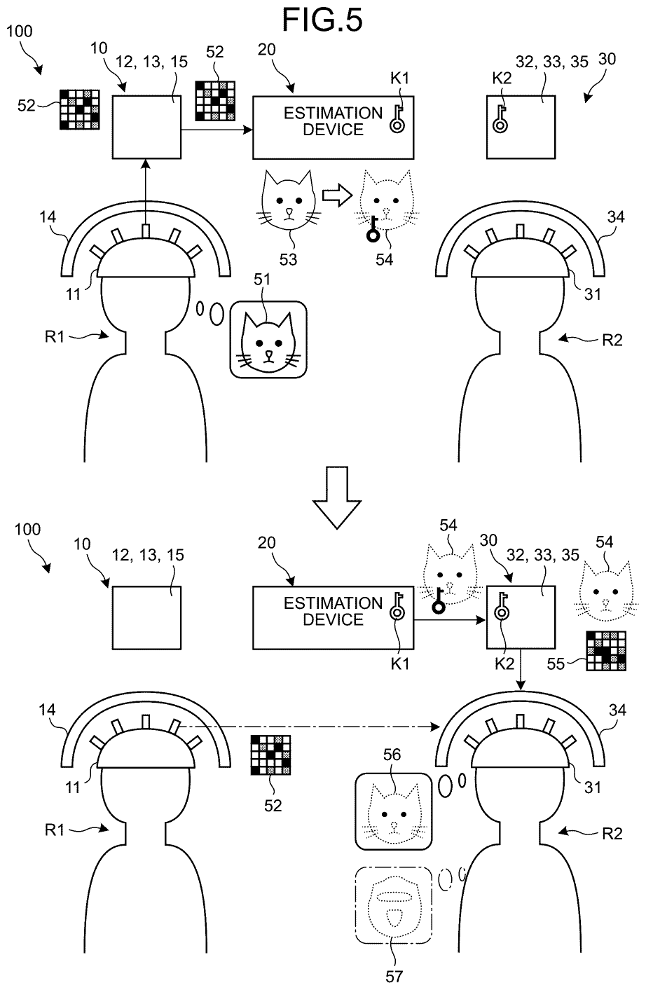

Given below is the explanation of a sensory communication method implemented in the sensory communication system 100 configured in the manner explained above. FIGS. 4 and 5 are diagrams that schematically illustrate an example of the operations performed in the sensory communication system 100. As illustrated in FIG. 4, prior to performing sensory communication, the delivery device 40 delivers the key information to the estimation device 20 and the second device 30 using quantum entanglement. In the delivery device 40, the generating unit 43 generates a pair of quanta having the relationship of quantum entanglement. For example, the generating unit 43 can generate photons by applying energy to the elementary particles present inside the brain of the first test subject R1, and can cause the generated photons to fall onto a nonlinear optical system so as to generate a pair of quanta having the relationship of quantum entanglement. Of the generated pair of quanta, the first quantum is delivered to the first processing unit 41 via the transmitting unit 44. The second quantum is delivered to the second processing unit 42 via the transmitting unit 44. The first processing unit 41 applies the third quantum having key information assigned thereto, and observes the quantum state of the first quantum. Then, the first processing unit 41 sends the first observation result, which is obtained as a result of performing observation, to the second processing unit 42 using a communication line of the wired type of the wireless type. The second processing unit 42 receives the first observation result from the first processing unit 41, and determines the quantum state of the second quantum based on the first observation result. Moreover, the second processing unit 42 observes the quantum state of the second quantum and obtains the second observation result. Then, the second processing unit 42 sends the determination result of determining the quantum state of the second quantum and sends the second observation result to the first processing unit 41 using a communication line of the wired type or the wireless type. The first processing unit 41 as well as the second processing unit 42 generates key information based on the first observation result, the second observation result, and the determination result. Then, the first processing unit 41 delivers generated key information K1 to the estimation device 20. The second processing unit 42 delivers generated key information K2 to the second device 30. The key information K1 and the key information K2 represent identical information.

In that state, as illustrated in FIG. 5, the first test subject R1 is made to perceive in such a way that the reference sensory information gets recalled. The following explanation is given with reference to an example in which the first test subject R1 visually perceives the face of a cat and recalls it as sensory information.

As illustrated in the upper part in FIG. 5, the detecting unit 11 detects the brain activation information 52 of the first test subject R1 who has perceived the face of a cat and recalled the recall sensory information 51. The communication unit 12 sends the brain activation information 52, which is detected by the detecting unit 11, to the estimation device 20.

In the estimation device 20, the communication unit 21 receives the brain activation information 52 that is sent from the first device 10. Based on the received brain activation information 52, the processing unit 22 estimates a reference sensory information 53. In that case, the processing unit 22 inputs the brain activation information 52 of the first test subject R1 to the first learning model. Based on the learning result about the correlation between the brain activation information 52 and the reference sensory information 53, the reference sensory information 53 corresponding to the input brain activation information 52 is output from the first learning model. The processing unit 22 obtains the reference sensory information 53, which is output, as the estimation result.

Based on the estimated reference sensory information 53, the processing unit 22 estimates the associated sensory information 54 that corresponds to the reference sensory information 53 for the second test subject R2. In that case, the processing unit 22 inputs the obtained reference sensory information 53 to the second learning model. Based on the learning result about the correlation between the reference sensory information 53 and the associated sensory information 54, the associated sensory information 54 corresponding to the input reference sensory information 53 is output from the second learning model. The processing unit 22 obtains the associated sensory information 54, which is output, as the estimation result. Moreover, the processing unit 22 encrypts the associated sensory information 54 using the key information K1 delivered by the delivery device 40. Then, the communication unit 21 sends the associated sensory information 54 in the encrypted form to the second device 30.

In the second device 30, the communication unit 32 receives the associated sensory information 54 that is sent from the estimation device 20. The processing unit 33 decrypts the associated sensory information 54 using the key information K2 that is delivered by the delivery device 40; and inputs the associated sensory information 54 in the decrypted form to the third learning model that is stored in the memory unit 35. Based on the learning result about the correlation between the associated sensory information 54 and the stimulation image information, stimulation image information 55 corresponding to the associated sensory information 54, which is input, is output from the third learning model. Based on the stimulation image information 55 that is output, the stimulation applying unit 34 bombards electromagnetic waves onto the brain of the second test subject R2 and thus applies a stimulation to the second test subject R2. As a result, the second test subject R2, to whom a stimulation is applied by the stimulation applying unit 34, recalls associated sensory information 56 corresponding to the stimulation image information 55. That is, the second test subject R2 recalls the visual information of the face of a cat as the associated sensory information 56.

Meanwhile, since there are individual differences between the first test subject R1 and the second test subject R2, the correspondence relationship between the brain activity state and the brain activation information is different between the two test subjects. For that reason, as illustrated in the lower part in FIG. 5, the brain activation information 52 of the first test subject R1 is directly sent to the second device 30 (as illustrated by a dash-dotted line). In the second device 30, when a stimulation corresponding to the brain activation information 52 is applied to the brain of the second test subject R2, there is a high possibility that the second test subject R2 recalls, as recall sensory information 57, visual information that is different than the face of a cat. In that case, the recall sensory information of the first test subject R1 is not properly transmitted to the second test subject R2.

In contrast, in the sensory communication system 100 according to the first embodiment, since the associated sensory information 54 of the second test subject R2 is estimated in the estimation device 20, the visual information about the face of a cat is properly transmitted from the first test subject R1 to the second test subject R2.

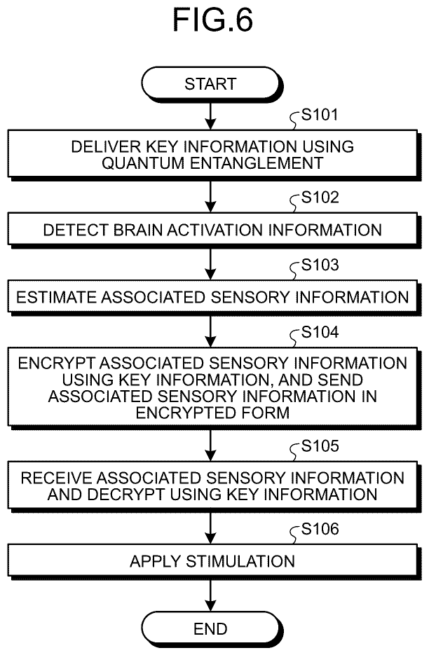

FIG. 6 is a flowchart for explaining an example of the operations performed in the sensory communication system 100. As illustrated in FIG. 6, in the sensory communication system 100, using quantum entanglement, the delivery device 40 delivers the key information K1 to the estimation device 20 and delivers the key information K2 to the second device 30 for enabling encryption and decryption (Step S101). In that state, the first device 10 detects the brain activation information of the first test subject R1 when the first test subject R1 perceives something (Step S102). Then, based on the brain activation information of the first test subject R1, the estimation device 20 estimates the reference sensory information that is recalled by the first test subject R1 against the perception; and, based on the estimated reference sensory information, the estimation device 20 estimates the associated sensory information corresponding to the reference sensory information regarding the second test subject R2 who is different than the first test subject R1 (Step S103). Moreover, using the key information K1 delivered from the delivery device 40, the estimation device 20 encrypts the associated sensory information, which is estimated, and sends the associated sensory information in the encrypted form to the second device 30 (Step S104). The second device 30 receives the associated sensory information in the encrypted form and decrypts it using the key information K2 delivered from the delivery device 40 (Step S105). The second device 30 applies a stimulation to the second test subject R2 in such a way that the associated sensory information, which is decrypted, is recalled (Step S106).

As explained above, the sensory communication system 100 according to the first embodiment includes: the estimation device 20 that encrypts brain activity information, which is based on the brain activity of a test subject, using key information and sends the encrypted brain activity information; the second device 30 that receives the brain activity information sent from the estimation device 20 and decrypts the received brain activity information using key information; and the delivery device 40 that delivers the key information to the estimation device 20 and the second device 30 using quantum entanglement.

The sensory communication method according to the first embodiment includes: encrypting, in the estimation device 20, that includes encrypting brain activity information, which is based on the brain activity of a test subject, using key information and sending the encrypted brain activity information; decrypting, in the second device 30, that includes receiving the brain activity information sent from the estimation device 20 and decrypting the received brain activity information using key information; and, delivering, in the delivery device 40, that includes delivering the key information to the estimation device 20 and the second device 30 using quantum entanglement.

The computer program product, in which a sensory communication program according to the embodiment is stored, causes the estimation device 20 to encrypt brain activity information, which is based on the brain activity of a test subject, using key information and send the encrypted brain activity information; causes the second device 30 to receive the brain activity information sent from the estimation device 20 and decrypt the received brain activity information using key information; and causes the delivery device 40 to deliver the key information to the estimation device 20 and the second device 30 using quantum entanglement.

According to such a configuration, even when there is differences in the brain activity between the first test subject R1 and the second test subject R2, the recall sensory information is properly transmitted from the first test subject R1 to the second test subject R2. At the time of transmission of the recall sensory information, since the recall sensory information is encrypted using the key information that is delivered from the delivery device 40 using quantum entanglement, it becomes possible to appropriately protect the recall sensory information representing the personal information of the test subject.

In the sensory communication system 100 according to the first embodiment, the delivery device 40 includes: the first processing unit that is disposed corresponding to the estimation device 20; the second processing unit that is disposed corresponding to the second device 30; the generating unit that generates a pair of quanta having the relationship of quantum entanglement; and the transmitting unit that, of the generated pair of quanta, transmits the first quantum to the first processing unit and transmits the second quantum to the second processing unit. The first processing unit observes the quantum state of the first quantum and sends the first observation result, which is obtained as a result of performing observation, to the second processing unit. The second processing unit observes the quantum state of the second quantum; determines the quantum state of the second quantum based on the first observation result sent from the first processing unit; and sends the second observation result, which is obtained as a result of performing observation, and the determination result, which is obtained as a result of performing determination, to the first processing unit. The first processing unit as well as the second processing unit generates key information based on the first observation result, the second observation result, and the determination result. The first processing unit delivers the generated key information to the estimation device 20, and the second processing unit delivers the generated key information to the second device 30. With such a configuration, it becomes possible to appropriately protect the recall sensory information representing the personal information of the test subject.

In the sensory communication system 100 according to the first embodiment, the delivery device 40 generates a pair of quanta using some of the elementary particles present inside the brain of the first test subject R1. For that reason, the pair of quanta can be generated in an efficient manner.

In the sensory communication system 100 according to the first embodiment, the delivery device 40 causes the photons to fall on a nonlinear optical system so that quantum entanglement is generated. With such a configuration, it becomes possible to appropriately generate a pair of quanta having the relationship of quantum entanglement.

In the sensory communication system 100 according to the first embodiment, when the brain activity information represents predetermined content, the delivery device 40 bombards photons onto the nonlinear optical system. With such a configuration, it becomes possible to generate a pair of quanta at an appropriate timing according to the brain activity information of the test subject.

In the sensory communication system 100 according to the first embodiment, when the brain activity information represents predetermined content, the delivery device 40 delivers the key information to the estimation device 20 and the second device 30 using quantum entanglement. However, when the brain activity information does not represent predetermined content, the estimation device 20 delivers the key information to the second device 30 without using quantum entanglement. With such a configuration, depending on the content estimated according to the recall sensory information, the communication method for communicating the encryption key can be changed, thereby resulting in the reduction of the processing load.

### Second Embodiment

A second embodiment is described below. In the first embodiment, the explanation is given about the case in which the sensory communication system 100 unidirectionally communicates the sensation from the first test subject R1 to the second test subject R2. In contrast, in the second embodiment, the sensory communication system 100 communicates the sensation also from the second test subject R2 to the first test subject R1. That is, the sensory communication system has a configuration enabling bidirectional communication of the sensation between the first test subject R1 and the second test subject R2.

Herein, the overall configuration of the sensory communication system 100 is identical to the first embodiment. In the second embodiment, in an identical manner to the first embodiment, the estimation device 20 functions as the sending device. However, unlike in the first embodiment, the first device 10 functions as the receiving device according to the second embodiment. Explained below with reference to FIGS. 1 and 2 is the configuration of the sensory communication system 100 from the side of the second device 30.

The second device 30 includes the detecting unit 31, the communication unit 32, the processing unit 33, the stimulation applying unit 34, and the memory unit 35. The processing unit 33, the stimulation applying unit 34, and the memory unit 35 are identical to the first embodiment. In an identical manner to the detecting unit 11 according to the first embodiment, the detecting unit 31 detects the brain activation information of the second test subject R2. The communication unit 32 sends the brain activation information, which is detected by the detecting unit 31, to the estimation device 20.

In an identical manner to the estimation device 20 according to the first embodiment, the estimation device 20 includes the communication unit 21, the processing unit 22, and the memory unit 23. The communication unit 21 is capable of performing wired communication or wireless communication. In the second embodiment, the communication unit 21 receives, for example, the brain activation information that is sent from the second device 30. The communication unit 21 sends, for example, the associated sensory information (explained later) that is estimated by the processing unit 22 to the first device 10.

Based on the detected brain activation information of the second test subject R2, the processing unit 22 estimates the recall sensory information (the reference sensory information) regarding the sensation recalled by the second test subject R2 against some perception. Regarding the second test subject R2, an experiment can be performed in advance, and recalling what type of recall sensory information results in what type of brain activation information can be obtained as the correspondence relationship. For example, the brain activation information detected from the second test subject R2 and the recall sensory information corresponding to the brain activation information can be associated as a single learning dataset, and a fourth learning model can be generated by performing machine learning of that learning dataset. The fourth learning model can be stored in, for example, the memory unit 23.

Moreover, based on the estimated reference sensory information, the processing unit 22 estimates the associated sensory information that represents the recall sensory information corresponding to the reference sensory information regarding the first test subject R1. In that case, the processing unit 22 can perform estimation based on the second learning model stored in the memory unit 23.

Furthermore, the processing unit 22 encrypts the associated sensory information that is estimated, In an identical manner to the first embodiment, the processing unit 22 extracts the key information based on the quantum state of the quanta delivered from the delivery device 40, and encrypts the associated sensory information using the extracted key information.

The first device 10 includes the detecting unit 11, the communication unit 12, the processing unit 13, the stimulation applying unit 14, and the memory unit 15. The detecting unit 11 and the communication unit 12 have an identical configuration to the configuration according to the first embodiment. Meanwhile, the communication unit 12 receives the associated sensory information that is sent from the estimation device 20.

The processing unit 13 decrypts the associated sensory information that is received by the communication unit 12. The processing unit 13 decrypts the associated sensory information using the key information that is delivered from the delivery device 40. Then, the processing unit 13 estimates the stimulation image information corresponding to the associated sensory information that is decrypted. The stimulation image information represents information indicating the details of the stimulation that is applied to the first test subject R1 by the stimulation applying unit 14.

The stimulation applying unit 14 applies a stimulation to the first test subject R1 by bombarding electromagnetic wave signals onto the target region in the brain of the first test subject R1 and thus activating the target region. In that case, in an identical manner to the stimulation applying unit 34 according to the first embodiment, the brain of the first test subject R1 is compartmentalized using, for example, a three-dimensional matrix made of voxels having the size equal to or smaller than few millimeters, and electromagnetic waves are bombarded on a voxel-by-voxel basis. The stimulation applying unit 14 can bombard electromagnetic waves based on the stimulation image information indicating the intensity of the electromagnetic waves to be bombarded and indicating the voxels in the three-dimensional matrix onto which the electromagnetic waves are to be bombarded. Regarding the information about what intensity of electromagnetic waves when bombarded onto which pixels in the brain of the first test subject R1 leads to the recall of what type of recall sensory information, the correspondence relationship can be obtained by performing an experiment in advance. For example, the stimulation image information regarding the first test subject R1 and the recall sensory information, which is recalled by the first test subject R1 when electromagnetic waves are bombarded based on the stimulation image information, can be associated to each other as a single learning dataset, and a fifth learning model can be generated by performing machine learning of that learning dataset. The fifth learning model can be stored in, for example, the memory unit 15 of the first device 10.

In an identical manner to the first learning model to the third learning model, the fourth learning model and the fifth learning model can be generated using, for example, a neural network represented by VGG16. At the time of generating the fourth learning model and the fifth learning model, the respective learning datasets are input to the neural network and the correlation among the datasets is learnt according to machine learning such as deep learning. Thus, the neural network is optimized by means of learning, and the learning models are generated. Meanwhile, the neural network is not limited to a convolutional neural network represented by VGG16, and learning models can be generated using other types of neural networks too.

The delivery device 40 delivers the key information, which is to be used in performing encryption in the estimation device 20 and in performing decryption in the first device 10, to the estimation device 20 and the first device 10 using quantum entanglement. Herein, the delivery device 40 delivers the key information to the estimation device 20 and the first device 10 before the encryption of the associated sensory information is carried out in the estimation device 20. The delivery device 40 includes the first processing unit 41, the second processing unit 42, the generating unit 43, and the transmitting unit 44. Those constituent elements have an identical configuration to the configuration according to first embodiment. In the second embodiment, the second processing unit 42 and the transmitting unit 44, which is connected to the second processing unit 42, are disposed corresponding to the first device 10 (as illustrated by a dash-dotted line in FIG. 1).

Given below is the explanation of the sensory communication method implemented using the sensory communication system 100 that is configured in the manner explained above. The sensory communication method for communicating the sensation from the first test subject R1 to the second test subject R2 is identical to the first embodiment. In the second embodiment, the explanation is given about the case in which the sensation is communicated from the second test subject R2 to the first test subject R1.

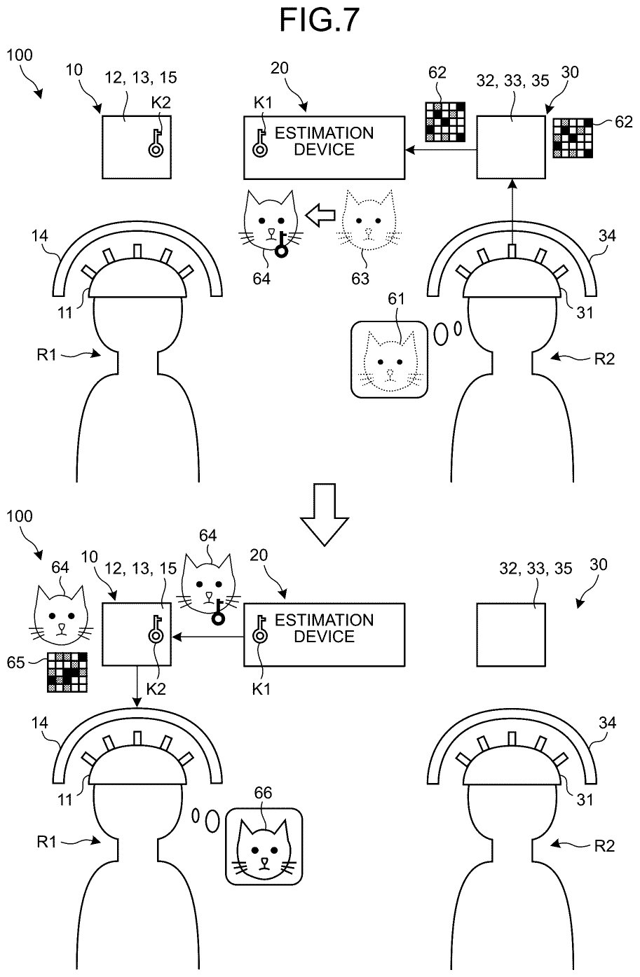

FIG. 7 is a diagram that schematically illustrates an example of the operations performed in the sensory communication system 100. As illustrated in FIG. 7, prior to performing the sensory communication of the second test subject R2, in an identical manner to the first embodiment, the delivery device 40 delivers the key information K1 and the key information K2, which is to be used in performing encryption and decryption, to the estimation device 20 and the second device 30, respectively, using quantum entanglement. In that case, for example, the generating unit 43 can generate photons by applying energy to the elementary particles present inside the brain of the second test subject R1, and can cause the generated photons to fall onto a nonlinear optical system so as to generate a pair of quanta having the relationship of quantum entanglement.

In that state, the second test subject R2 is made to perceive in such a way that the reference sensory information gets recalled. The following explanation is given with reference to an example in which the second test subject R2 visually perceives the face of a cat and recalls it as sensory information. In the example explained below, the face of a cat is assumed to be identical to the face of a cat according to the first embodiment.

As illustrated in the upper part of FIG. 7, the detecting unit 31 detects brain activation information 62 of the second test subject R2 who has perceived the face of a cat and recalled recall sensory information 61. The communication unit 32 sends the brain activation information 62, which is detected by the detecting unit 31, to the estimation device 20.

In the estimation device 20, the communication unit 21 receives the brain activation information 62 that is sent from the second device 30. Based on the received brain activation information 62, the processing unit 22 estimates reference sensory information 63. In that case, the processing unit 22 inputs the brain activation information 62 of the second test subject R2 to the fourth learning model. Based on the learning result about the correlation between the brain activation information 62 and the reference sensory information 63, the reference sensory information 63 corresponding to the input brain activation information 62 is output from the fourth learning model. The processing unit 22 obtains the reference sensory information 53, which is output, as the estimation result.

Based on the estimated reference sensory information 63, the processing unit 22 estimates associated sensory information 64 that corresponds to the reference sensory information 63 for the first test subject R1. In that case, the processing unit 22 inputs the obtained reference sensory information 63 to the second learning model. Based on the learning result about the correlation between the reference sensory information 63 and the associated sensory information 64, the associated sensory information 64 corresponding to the input reference sensory information 63 is output from the second learning model. The processing unit 22 obtains the associated sensory information 64, which is output, as the estimation result. Moreover, the processing unit 22 encrypts the associated sensory information 64 using the key information K1 delivered by the delivery device 40. Then, the communication unit 21 sends the associated sensory information 64 in the encrypted form to the first device 10.

As illustrated in the lower part of FIG. 7, in the first device 10, the communication unit 12 receives the associated sensory information 64 that is sent from the estimation device 20. The processing unit 13 decrypts the associated sensory information 64 using the key information K2 that is delivered by the delivery device 40, and inputs the associated sensory information 64 in the decrypted form to the fifth learning model that is stored in the memory unit 15. Based on the learning result about the correlation between the associated sensory information 64 and a stimulation image information 65, the stimulation image information 65 corresponding to the associated sensory information 64, which is input, is output from the fifth learning model. Based on the stimulation image information 65 that is output, the stimulation applying unit 14 bombards electromagnetic waves onto the brain of the first test subject R1 and thus applies a stimulation to the first test subject R1. As a result, the first test subject R1, to whom a stimulation is applied by the stimulation applying unit 14, recalls associated sensory information 66 corresponding to the stimulation image information 65. That is, the first test subject R1 recalls the visual information of the face of a cat as the associated sensory information 66. In this way, the visual information about the face of a cat is transmitted from the second test subject R2 to the first test subject R1.

As explained above, in the sensory communication system 100 according to the second embodiment, the reference sensory information represents the recall sensory information that is recalled by the second test subject R2 whose brain activation information is detected. With such a configuration, the recall sensory information of the second test subject R2 is directly associated to the recall sensory information of the first test subject R1, thereby enabling appropriate transmission of the recall sensory information between the test subjects having differences in the brain activity. Moreover, at the time of transmission of the recall sensory information, since the recall sensory information is encrypted according to the key information that is delivered using quantum entanglement, it becomes possible to appropriately protect the recall sensory information representing the personal information of the test subject.

### Third Embodiment

A third embodiment is described below. In the first and second embodiments described above, the recall sensory information of the test subject whose brain activation information is detected is treated as the reference sensory information. In contrast, in a third embodiment, the explanation is given about a case in which standard sensory information that is extracted based on the recall sensory information corresponding among a plurality of test subjects is treated as the reference sensory information. Herein, the overall configuration of the sensory communication system 100 is identical to the first embodiment.

In the estimation device 20, in the case of estimating the associated sensory information from the reference sensory information, the standard sensory information is used as the reference sensory information. For example, when a plurality of test subjects has identical perception in the form of looking at an identical image, the average value of the sets if brain activation information detected across the plurality of test subjects can be treated as the standard sensory information. Thus, the standard sensory information has a smaller individual difference attributed to the acquired memory, and represents the recall sensory information of an average person.

At the time of learning the recall sensory information corresponding among a plurality of test subjects, the standard sensory information can be extracted from the learning result. For example, the brain activation information of a specific test subject (for example, the first test subject R1 or the second test subject R2) and the standard sensory information (the average value of the brain activation information of a plurality of test subjects) is treated as a single learning dataset, and a sixth learning model can be generated by performing machine learning of that learning dataset. At the time of generating the sixth learning model, the standard sensory information is extracted from a plurality of sets of recall sensory information included in the learning dataset, and the extracted standard sensory information can be associated to the individual sets of brain activation information included in the learning dataset. As a result, regarding the recall sensory information of different types, such as the recall sensory information about the sense of vision when a particular object is seen, the recall sensory information about the sense of hearing when a particular sound is heard, and the recall sensory information about the sense of touch when a particular object is touched; the sixth learning model is generated in which the correspondence relationship between the brain activation information of each of a plurality of test subjects and the standard sensory information is machine-learnt. The sixth learning model can be stored in, for example, the memory unit 35.

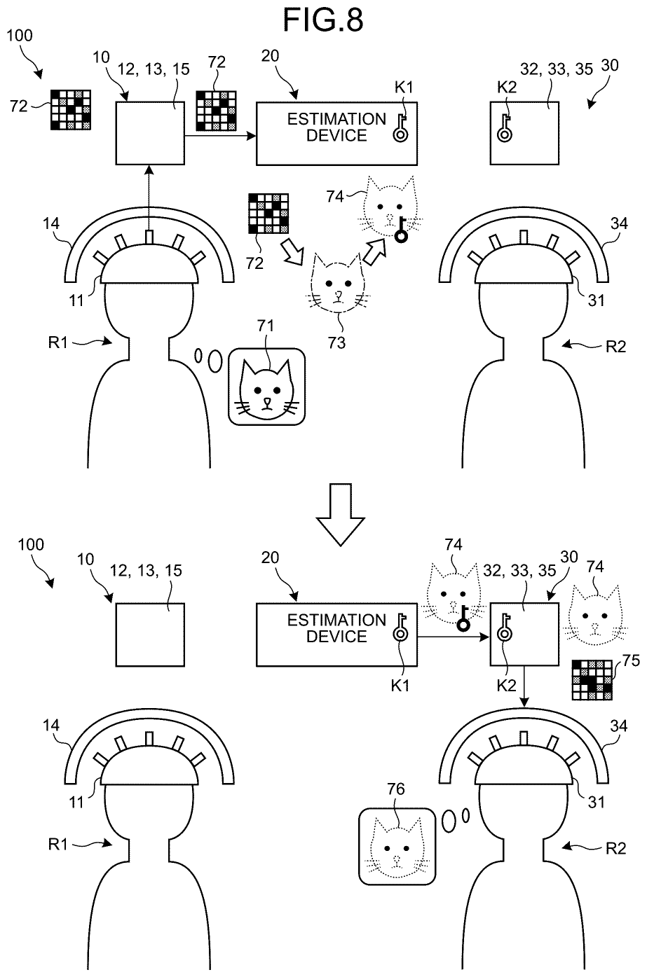

Given below is the explanation of the sensory communication method implemented in the sensory communication system 100 that is configured in the manner explained above. FIG. 8 is a diagram that schematically illustrates an example of the operations performed in the sensory communication system 100. As illustrated in FIG. 8, prior to performing sensory communication, in an identical manner to the first embodiment, the delivery device 40 delivers the key information K1 and the key information K2, which is to be used in performing encryption and decryption, to the estimation device 20 and the second device 30, respectively, using quantum entanglement. In that case, for example, the generating unit 43 can generate photons by applying energy to the elementary particles present inside the brain of the first test subject R1, and can cause the generated photons to fall onto a nonlinear optical system so as to generate a pair of quanta having the relationship of quantum entanglement.

In that state, for example, in the case in which recall sensory information 71, which corresponds to the time when the first test subject R1 perceives something, is to be transmitted to the second test subject R2; the first device 10 obtains brain activation information 72 of the first test subject R1 and sends it to the estimation device 20.

In the estimation device 20, the processing unit 22 inputs the brain activation information 72, which is sent from the first device 10, and identification information of the second test subject R2, to whom the recall sensory information is to be sent, to the sixth learning model that is stored in the memory unit 35. In the sixth model, standard sensory information 73 corresponding to the brain activation information 72 is calculated, and the recall sensory information of the second test subject R2 that is associated to the standard sensory information 73 is output as associated sensory information 74. Then, the processing unit 22 encrypts the associated sensory information 74, which is output, using the key information K1 that is delivered by the delivery device 40. The communication unit 21 sends the associated sensory information 74 in the encrypted form to the second device 30.

In an identical manner to the first embodiment, the second device 30 receives the associated sensory information 74 from the estimation device 20, and decrypts it using the key information K2 that is delivered from the delivery device 40. The second device 30 obtains stimulation image information 75 based on the associated sensory information 74 in the decrypted form. The stimulation applying unit 34 bombards electromagnetic waves onto the brain of the second test subject R2 based on the stimulation image information 75 that is output, and thus applies a stimulation to the second test subject R2. Upon being applied with a stimulation by the stimulation applying unit 34, the second test subject R2 recalls associated sensory information 76 corresponding to the stimulation image information 75.

As explained above, in the sensory communication system 100 according to the third embodiment, the reference sensory information represents the standard sensory information 63 that is extracted based on the recall sensory information corresponding among a plurality of test subjects. In that configuration, the standard sensory information 63 that is extracted based on the recall sensory information corresponding among a plurality of test subjects is used as the reference sensory information. Hence, the recall sensory information can be properly communicated among a large number of test subjects. Moreover, at the time of transmitting the recall sensory information, it is encrypted according to the key information that is delivered using quantum entanglement. Hence, it becomes possible to appropriately protect the recall sensory information representing the personal information of the test subject.

Although the application concerned has been described with respect to specific embodiments for a complete and clear disclosure, the appended claims are not to be thus limited but are to be construed as embodying all modifications and alternative constructions that may occur to one skilled in the art that fairly fall within the basic teaching herein set forth. For example, in the embodiments described above, the explanation is given with reference to the recall sensory information related to the sense of vision. However, that is not the only possible case. Thus, as long as the recall sensory information enables detection of the brain activation information, the recall sensory information can be of some other type. Alternatively, for example, it is possible to use detailed recall sensory information obtained by coordinating among the recall sensory information of the five senses. Moreover, in the embodiments described above, the explanation is given for the case in which, as the brain activity information, the associated sensory information is encrypted and decrypted using the key information. However, that is not the only possible case. Alternatively, for example, as the brain activity information, as long as the information is based on the brain activity of the test subject, some other type of information other than the associated sensory information, such as the recall sensory information, or the reference sensory information, or the information based on the brain waves, can be encrypted and decrypted using the key information.

Meanwhile, in the sensory communication system 100 according to the embodiments described above, the recall sensory information of the first type R1 at a first point of time can be used for making the first test subject R1 recall at a second point of time, which arrives after the first point of time. The first device 10 obtains the reference sensory information of the first test subject R1 at the first point of time, and sends the reference sensory information to the estimation device 20. The estimation device 20 stores the reference sensory information in the memory unit 25. Then, based on the reference sensory information of the first test subject R1 at the first point of time, the estimation device 20 estimates the associated sensory information corresponding to the first test subject R1 at the second point of time, and sends the estimation result to the first device 10. In the first device 10, the stimulation applying unit 14 applies a stimulation to the first test subject R1 in such a way that the first test subject R1 recalls the associated sensory information that is estimated. In that case, the sensation of the first test subject R1 at the first point of time can be relived at the second point of time. In that case, the sensory communication system 100 sends the recall sensory information between the first test subject R1 in the past (at the first point of time) and the first test subject R1 at the time of applying a stimulation (at the second point of time), that is, sends the recall sensory information to the same person. Meanwhile, in the embodiments described above, performing encryption serves as the premise. However, when there is no risk of an unauthorized use such as wiretapping, the estimation device 20 can send the recall sensory information to the first device 10 without performing encryption. As a result, from the perspective of power consumption, the processing time required for encryption and decryption can be streamlined.

According to the application concerned, it becomes possible to provide a sensory communication system, a sensory communication method, and a computer program product that enable protection of the personal information of the test subject in an appropriate manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sensory transmission system comprising:
a sending device that encrypts brain activity information, which is based on brain activity of a test subject, using key information, and sends the brain activity information in encrypted form;
a receiving device that receives the brain activity information sent from the sending device, and decrypts the received brain activity information using the key information; and
a delivery device that delivers the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.

2. The sensory communication system according to claim 1, wherein
the delivery device includes
a first processing unit that is disposed corresponding to the sending device,
a second processing unit that is disposed corresponding to the receiving device,
a generating unit that generates a pair of quanta having the relationship of quantum entanglement, and
a transmitting unit that, of the generated pair of quanta, transmits a first quantum to the first processing unit, and transmits a second quantum to the second processing unit,
the first processing unit observes quantum state of the first quantum, and sends a first observation result, which is obtained as a result of performing observation, to the second processing unit,
the second processing unit
observes quantum state of the second quantum,
determines quantum state of the second quantum based on the first observation result sent from the first processing unit, and
sends, to the first processing unit, a second observation result obtained as a result of performing observation and a determination result obtained as a result of performing determination,
the first processing unit as well as the second processing unit generates the key information based on the first observation result, the second observation result, and the determination result,
the first processing unit delivers the generated key information to the sending device, and
the second processing unit delivers the generated key information to the receiving device.

3. The sensory communication system according to claim 2, wherein the delivery device generates the pair of quanta using some of elementary particles present inside brain of the test subject.

4. The sensory communication system according to claim 1, wherein the delivery device causes photons to fall onto a nonlinear optical system, so that quantum entanglement occurs.

5. A sensory communication method comprising:
encrypting, in a sending device, that includes encrypting brain activity information, which is based on brain activity of a test subject, using key information, and sending the brain activity information in encrypted form;
decrypting, in a receiving device, that includes receiving the brain activity information sent from the sending device, and decrypting the received brain activity information using the key information; and
delivering, in a delivery device, that includes delivering the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.

6. A non-transitory computer-readable storage medium storing a program causing a computer to execute,
by a sending device, causes the sending device to perform encrypting brain activity information, which is based on brain activity of a test subject, using key information, and sending the brain activity information in encrypted form;
by a receiving device, causes the receiving device to perform receiving the brain activity information sent from the sending device, and decrypting the received brain activity information using the key information; and
by a delivery device, causes the delivery device to perform delivering the key information to the sending device and the receiving device using quantum entanglement,
when the brain activity information represents predetermined content, the delivery device delivers the key information to the sending device and the receiving device using quantum entanglement, and
when the brain activity information does not represent predetermined content, the sending device delivers the key information to the receiving device without using quantum entanglement.
